(19) United States
(12) Patent Application Publication
(10) Pub. No.: US 2024/0371035 A1
(43) Pub. Date: Nov. 7, 2024

(54) CAMERA AND LIDAR CROSS-SENSOR CALIBRATION

(71) Applicant: QUALCOMM Incorporated, San Diego, CA (US)

(72) Inventors: Sai Madhuraj Jadhav, San Diego, CA (US); Amin Ansari, Federal Way, WA (US); Avdhut Joshi, San Marcos, CA (US)

(21) Appl. No.: 18/310,132

(22) Filed: May 1, 2023

(51) Int. Cl. G06T 7/80; G01S 7/497; G01S 17/86; G01S 17/89; G01S 17/931; G06T 5/00; G06T 5/20; G06T 7/13; G06T 7/521; H04N 17/00

(52) U.S. Cl. CPC G06T 7/80; G01S 7/497; G01S 17/86; G01S 17/89; G01S 17/931; G06T 5/20; G06T 5/70; G06T 7/13; G06T 7/521; H04N 17/002; G06T 2207/10028; G06T 2207/20192; G06T 2207/30252

(57) ABSTRACT

A processing system for cross-sensor calibration is configured to perform a first edge detection process on a camera image to generate an edge detected camera image, and perform a second edge detection process on a point cloud frame to generate an edge detected point cloud frame. The processing system projects the edge detected point cloud frame onto the edge detected camera image using an initial calibration matrix, determines an objective function representing an overlap of points in the edge detected point cloud frame and corresponding edge pixel values in the edge detected camera image, and determines a final calibration matrix based on the objective function.

### TECHNICAL FIELD

This disclosure relates to sensor systems, including sensor systems for advanced driver-assistance systems (ADAS).

### BACKGROUND

An autonomous driving vehicle is a vehicle that is configured to sense the environment around the vehicle, such as the existence and location of other objects, and operating without human control. An autonomous driving vehicle may include a LiDAR (Light Detection and Ranging) system or other sensor system for sensing point cloud data indicative of the existence and location of other objects around the autonomous driving vehicle. In some examples, such an autonomous driving vehicle may be referred to as an ego vehicle. A vehicle having an ADAS is a vehicle that includes systems which may assist a driver in operating the vehicle, such as parking or driving the vehicle.

### SUMMARY

The present disclosure generally relates to techniques and devices for performing cross-sensor calibration, including calibrating the outputs of a LiDAR sensor (e.g., a three-dimensional (3D) point cloud) such that the points in the point cloud more closely match the positions of features in a camera image. Cameras and LiDAR sensors may be used in vehicular and/or robotic applications as sources of information that may be used to determine the location, pose, and potential actions of physical objects in the outside world. However, cameras and LiDAR sensors are not always running at the same frequency and might not be synchronized. As such, features in the point cloud and camera image may not always be in the same location with relation to each other. This disclosure describes techniques for calibrating the output of LiDAR and cameras such that features in the output point cloud frames and camera images are more closely aligned.

In an example of the disclosure, a processing system may receive a plurality of camera images from a camera and a plurality of point cloud frames from a LiDAR sensor. The processing system may select a camera image and then determine a point cloud frame that was generated closest in time to the selected camera image. The processing system may then detect edges in both the camera image and the point cloud frame. In general, edges in the camera image and point cloud frame are indicative of physical objects in the scene. In some examples, the processing system may also apply a smoothing filter on the edges in the camera image. In vehicular applications, the processing system may also apply a motion compensation process to the point cloud frame, as the LiDAR sensor may capture the point cloud frame while the car is moving.

The processing system may then project the points in the edge detected point cloud frame onto the edge detected camera image using an initial calibration matrix. The initial calibration matrix may represent an estimated or predetermined amount of rotation and translation to apply to the edge detected point cloud frame. The processing system may then compute an objective function that represents an overlap points in the edge detected point cloud frame and the corresponding edge values in the edge detected camera image. The higher the value of the objective function, the more closely the edges in the point cloud frame and camera image match up, thus representing a more accurate cross-sensor calibration.

The processing system may determine a final calibration matrix based on the value of the objective function. For example, the processing system may optimize the value of the objective function by iteratively updating the values of the calibration matrix, reprojecting the edge detected point cloud frame on to the edge detected camera image using the updated calibration matrix, and recomputing the objective function. Once the value of the objective function has been optimized, a final calibration matrix used to determine the optimized objective function is returned. The final calibration matrix may then be used by applications that utilize both camera and LiDAR sensor outputs together, such as monocular depth estimation.

The techniques of this disclosure results in a more accurate calibration of cameras and LiDAR sensors compared to other manual calibration techniques. In addition, the techniques of this disclosure allow for both offline (e.g., as part of manufacturing process) calibration of camera and LiDAR sensors, as well as periodic recalibration of such sensors while in use, as the process uses the output of the sensors alone, and not any test structures or other manual processes to perform the calibration. As such, the techniques of this disclosure allow for continued and automatic calibration of LiDAR and camera sensors, even after final manufacturing has been completed.

In one example, this disclosure describes an apparatus for cross-sensor calibration, the apparatus comprising a memory for storing a camera image and a point cloud frame, and one or more processors implemented in circuitry and in communication with the memory, the one or more processors configured to perform a first edge detection process on the camera image to generate an edge detected camera image, perform a second edge detection process on the point cloud frame to generate an edge detected point cloud frame, project the edge detected point cloud frame onto the edge detected camera image using an initial calibration matrix, determine a value of an objective function representing an overlap of points in the edge detected point cloud frame and corresponding edge pixel values in the edge detected camera image, and determine a final calibration matrix based on the value of the objective function.

In another example, this disclosure describes a method for cross-sensor calibration, the method comprising performing a first edge detection process on a camera image to generate an edge detected camera image, performing a second edge detection process on a point cloud frame to generate an edge detected point cloud frame, projecting the edge detected point cloud frame onto the edge detected camera image using an initial calibration matrix, determining a value of an objective function representing an overlap of points in the edge detected point cloud frame and corresponding edge pixel values in the edge detected camera image, and determining a final calibration matrix based on the value of the objective function.

In another example, this disclosure describes a device comprising means for performing a first edge detection process on a camera image to generate an edge detected camera image, means for performing a second edge detection process on a point cloud frame to generate an edge detected point cloud frame, means for projecting the edge detected point cloud frame onto the edge detected camera image using an initial calibration matrix, means for determining a value of an objective function representing an overlap of points in the edge detected point cloud frame and corresponding edge pixel values in the edge detected camera image, and means for determining a final calibration matrix based on the value of the objective function.

In another example, this disclosure describes a non-transitory computer-readable storage medium storing instructions, which, when executed, cause one or more processors to perform a first edge detection process on a camera image to generate an edge detected camera image, perform a second edge detection process on a point cloud frame to generate an edge detected point cloud frame, project the edge detected point cloud frame onto the edge detected camera image using an initial calibration matrix, determine a value of an objective function representing an overlap of points in the edge detected point cloud frame and corresponding edge pixel values in the edge detected camera image, and determine a final calibration matrix based on the value of the objective function.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example processing system according to one to more aspects of this disclosure.

FIG. 2 illustrates an example of differing time synchronizations in camera and LiDAR systems.

FIG. 3 is a conceptual drawing illustrating one example of a point cloud overlaid on a camera image.

FIG. 4 is a conceptual drawing illustrating example outputs of a camera edge detection process for the cross-sensor calibration of the disclosure.

FIG. 5 is a flowchart illustrating one example process for the cross-sensor calibration of the disclosure.

FIG. 6 is a flow diagram illustrating another example process for the cross-sensor calibration of the disclosure.

FIG. 7 is a conceptual diagram illustrating two example techniques for de-weighting vegetation in edge detected point cloud frames for the cross-sensor calibration of the disclosure.

FIG. 8 is a conceptual diagram illustrating another example technique for de-weighting vegetation in edge detected point cloud frames for the cross-sensor calibration of the disclosure.

FIG. 9 is a conceptual diagram illustrating an example technique for de-weighting certain points in edge detected point cloud frames for the cross-sensor calibration of the disclosure.

FIG. 10 is a conceptual diagram showing an example output using the cross-sensor calibration techniques of this disclosure.

FIG. 11 is a conceptual diagram illustrating an example architecture for depth estimation for use with the cross-sensor calibration of the disclosure.

### DETAILED DESCRIPTION

Camera and LiDAR systems may be used together in various different robotic and vehicular applications. One such vehicular application is an advanced driver assistance system (ADAS). ADAS is a system that utilizes both camera and LiDAR sensor technology to improve driving safety, comfort, and overall vehicle performance. This system combines the strengths of both sensors to provide a more comprehensive view of a vehicle's surroundings, enabling the ADAS to better assist the driver in various driving scenarios.

In some examples, the camera-based system is responsible for capturing high-resolution images and processing them in real time. The output images of such a camera-based system may be used in applications such as depth estimation, object detection, and/or pose detection, including the detection and recognition of objects, such as other vehicles, pedestrians, traffic signs, and lane markings. Cameras may be particularly good at capturing color and texture information, which is useful for accurate object recognition and classification.

LiDAR sensors emit laser pulses to measure the distance, shape, and relative speed of objects around the vehicle. LiDAR sensors provide 3D data, enabling the ADAS to create a detailed map of the surrounding environment. LiDAR may be particularly effective in low-light or adverse weather conditions, where camera performance may be hindered. In some examples, the output of a LiDAR sensor may be used as partial ground truth data for performing neural network-based depth information on corresponding camera images.

By fusing the data gathered from both camera and LiDAR sensors, the ADAS can deliver enhanced situational awareness and improved decision-making capabilities. This enables various driver assistance features such as adaptive cruise control, lane keeping assist, pedestrian detection, automatic emergency braking, and parking assistance. The combined system can also contribute to the development of semi-autonomous and fully autonomous driving technologies, which may lead to a safer and more efficient driving experience.

The present disclosure generally relates to techniques and devices for performing cross-sensor calibration, including cross calibrating the outputs of a LiDAR sensor (e.g., a 3D point cloud) and a camera (e.g., a two-dimensional (2D) image). As described above, cameras and LiDAR sensors may be used in vehicular and/or robotic applications as sources of information that may be used to determine the location, pose, and potential actions of physical objects in the outside world. However, these sensors are not always running at the same frequency and might not be synchronized in the time or spatial domains. As such, features in the point cloud and camera image may not always be in the same location with relation to each other. This disclosure describes techniques for calibrating the output of LiDAR sensors and cameras such that features in the output point cloud frames and camera images are more closely aligned.

In an example of the disclosure, a processing system may receive a plurality of camera images from a camera and a plurality of point cloud frames from a LiDAR sensor. The processing system may select a camera image and then determine a point cloud frame that was generated closest in time to the selected camera image. The processing system may then detect edges in both the camera image and the point cloud frame. In general, edges in the camera image and point cloud frame are indicative of physical objects in the scene. In some examples, the processing system may also apply a smoothing filter on the edges in the camera image. In vehicular applications, the processing system may also apply a motion compensation process to the point cloud frame, as the LiDAR sensor may capture the point cloud frame while the car is moving.

The processing system may then project the points in the edge detected point cloud frame onto the edge detected camera image using an initial calibration matrix. The initial calibration matrix may represent an estimated or predetermined amount of rotation and translation to apply to the edge detected point cloud frame. The processing system may then compute a value of an objective function that represents an overlap points in the edge detected point cloud frame and the corresponding edge values in the edge detected camera image. The higher the value(s) of the objective function, the more closely the edges in the point cloud frame and camera image match up, thus representing a more accurate cross-sensor calibration.

The processing system may determine a final calibration matrix based on the value of the objective function. For example, the processing system may optimize the value of the objective function by iteratively updating the values of the calibration matrix, reprojecting the edge detected point cloud frame on to the edge detected camera image using the updated calibration matrix, and recomputing the objective function. Once the value of the objective function has been optimized, a final calibration matrix used to determine the optimized objective function is returned. The final calibration matrix may then be used by applications that utilize both camera and LiDAR sensor outputs together, such as monocular depth estimation.

The techniques of this disclosure results in a more accurate calibration of cameras and LiDAR sensors compared to other manual calibration techniques. In addition, the techniques of this disclosure allow for both offline (e.g., as part of manufacturing process) calibration of camera and LiDAR sensors, as well as periodic recalibration of such sensors while in use, as the process uses the output of the sensors alone, and not any test structures or other manual processes to perform the calibration. As such, the techniques of this disclosure allow for continued and automatic calibration of LiDAR and camera sensors, even after final manufacturing has been completed.

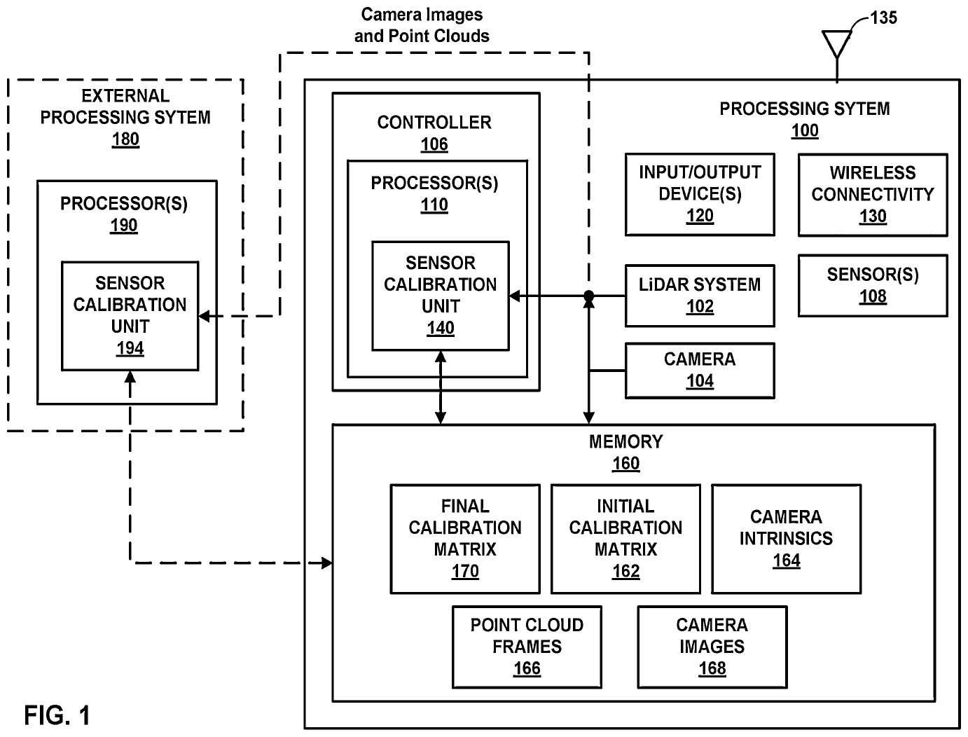

FIG. 1 is a block diagram illustrating an example processing system according to one to more aspects of this disclosure. Processing system 100 may be used in a vehicle, such as an autonomous driving vehicle or an assisted driving vehicle (e.g., a vehicle having an advanced driver-assistance systems (ADAS) or an “ego vehicle”). In such an example, processing system 100 may represent an ADAS. In other examples, processing system 100 may be used in other robotic applications that may include both a camera and a LiDAR system.

Processing system 100 may include LiDAR system 102, camera 104, controller 106, one or more sensor(s) 108, input/output device(s) 120, wireless connectivity component 130, and memory 160. LiDAR system 102 may include one or more light emitters (e.g., lasers) and one or more light sensors. LiDAR system 102 may be deployed in or about a vehicle. For example, LiDAR system 102 may be mounted on a roof of a vehicle, in bumpers of a vehicle, and/or in other locations of a vehicle. LiDAR system 102 may be configured to emit light pulses and sense the light pulses reflected off of objects in the environment. LiDAR system 102 may emit such pulses in a 360 degree field around so as to detect objects within the 360 degree field, such as objects in front of, behind, or beside a vehicle. While described herein as including LiDAR system 102, it should be understood that another distance or depth sensing system may be used in place of LiDAR system 102. The output of LiDAR system 102 are called point clouds or point cloud frames.

A point cloud frame output by LiDAR system 102 is a collection of 3D data points that represent the surface of objects in the environment. These points are generated by measuring the time it takes for a laser pulse to travel from the sensor to an object and back. Each point in the cloud has at least three attributes: x, y, and z coordinates, which represent its position in a Cartesian coordinate system. Some LiDAR systems also provide additional information for each point, such as intensity, color, and classification.

Intensity (also called reflectance) is a measure of the strength of the returned laser pulse signal for each point. The value of the intensity attribute depends on various factors, such as the reflectivity of the object's surface, distance from the sensor, and the angle of incidence. Intensity values can be used for several purposes, including distinguishing different materials, and enhancing visualization: Intensity values can be used to generate a grayscale image of the point cloud, helping to highlight the structure and features in the data.

Color information in a point cloud is usually obtained from other sources, such as digital cameras mounted on the same platform as the LiDAR sensor, and then combined with the LiDAR data. The color attribute consists of color values (e.g., red, green, and blue (RGB)) values for each point. The color values may be used to improve visualization and aid in enhanced classification (e.g., the color information can aid in the classification of objects and features in the scene, such as vegetation, buildings, and roads.)

Classification is the process of assigning each point in the point cloud to a category or class based on its characteristics or its relation to other points. The classification attribute may be an integer value that represents the class of each point, such as ground, vegetation, building, water, etc. Classification can be performed using various algorithms, often relying on machine learning techniques or rule-based approaches.

Camera 104 may be any type of camera configured to capture video or image data in the environment around processing system 100 (e.g., around a vehicle). For example, camera 104 may include a front facing camera (e.g., a front bumper camera, a front windshield camera, and/or a dashcam), a back facing camera (e.g., a backup camera), side facing cameras (e.g., cameras mounted in sideview mirrors). Camera 104 may be a color camera or a grayscale camera. In some examples, camera 104 may be a camera system including more than one camera sensor. While techniques of this disclosure will be described with reference to a 2D photographic camera, the techniques of this disclosure may be applied to the outputs of other sensors that capture information at a higher frame rate than a LiDAR sensor, including a sonar sensor, a radar sensor, an infrared camera, and/or a time-of-flight (ToF) camera.

Wireless connectivity component 130 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity component 130 is further connected to one or more antennas 135.

Processing system 100 may also include one or more input and/or output devices 120, such as screens, touch-sensitive surfaces (including touch-sensitive displays), physical buttons, speakers, microphones, and the like. Input/output device(s) 120 (e.g., which may include an I/O controller) may manage input and output signals for processing system 100. In some cases, input/output device(s) 120 may represent a physical connection or port to an external peripheral. In some cases, input/output device(s) 120 may utilize an operating system. In other cases, input/output device(s) 120 may represent or interact with a modem, a keyboard, a mouse, a touchscreen, or a similar device. In some cases, input/output device(s) 120 may be implemented as part of a processor (e.g., a processor of processor(s) 110). In some cases, a user may interact with a device via input/output device(s) 120 or via hardware components controlled by input/output device(s) 120.

Controller 106 may be an autonomous or assisted driving controller (e.g., an ADAS) configured to control operation of processing system 100 (e.g., including the operation of a vehicle). For example, controller 106 may control acceleration, braking, and/or navigation of vehicle through the environment surrounding vehicle. Controller 106 may include one or more processors, e.g., processor(s) 110. Processor(s) 110 may include one or more central processing units (CPUs), such as single-core or multi-core CPUs, graphics processing units (GPUs), digital signal processor (DSPs), neural processing unit (NPUs), multimedia processing units, and/or the like. Instructions executed by processor(s) 110 may be loaded, for example, from memory 160 and may cause processor(s) 110 to perform the operations attributed to processor(s) in this disclosure. In some examples, one or more of processor(s) 110 may be based on an ARM or RISC-V instruction set.

An NPU is generally a specialized circuit configured for implementing all the necessary control and arithmetic logic for executing machine learning algorithms, such as algorithms for processing artificial neural networks (ANNs), deep neural networks (DNNs), random forests (RFs), kernel methods, and the like. An NPU may sometimes alternatively be referred to as a neural signal processor (NSP), a tensor processing unit (TPU), a neural network processor (NNP), an intelligence processing unit (IPU), or a vision processing unit (VPU).

Processor(s) 110 may also include one or more sensor processing units associated with LiDAR system 102, camera 104, and/or sensor(s) 108. For example, processor(s) 110 may include one or more image signal processors associated with camera 104 and/or sensor(s) 108, and/or a navigation processor associated with sensor(s) 108, which may include satellite-based positioning system components (e.g., GPS or GLONASS) as well as inertial positioning system components. In some aspects, sensor(s) 108 may include direct depth sensing sensors, which may function to determine a depth of or distance to objects within the environment surrounding processing system 100 (e.g., surrounding a vehicle).

Processing system 100 also includes memory 160, which is representative of one or more static and/or dynamic memories, such as a dynamic random access memory, a flash-based static memory, and the like. In this example, memory 160 includes computer-executable components, which may be executed by one or more of the aforementioned components of processing system 100.

Examples of memory 160 include random access memory (RAM), read-only memory (ROM), or a hard disk. Examples of memory 160 include solid state memory and a hard disk drive. In some examples, memory 160 is used to store computer-readable, computer-executable software including instructions that, when executed, cause a processor to perform various functions described herein. In some cases, memory 160 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within memory 160 store information in the form of a logical state.

Processing system 100 and/or components thereof may be configured to perform the techniques for cross sensor calibration described herein. For example, processor(s) 110 may include sensor calibration unit 140. Sensor calibration unit 140 may be implemented in software, firmware, and/or any combination of hardware described herein. As will be described in more detail below, sensor calibration unit 140 may be configured to receive a plurality of camera images 168 captured by camera 104 and receive a plurality of point cloud frames 166 captured by LiDAR system 102. Sensor calibration unit 140 may be configured to receive camera images 168 and point cloud frames 166 directly from camera 104 and LiDAR system 102, respectively, or from memory 160.

Sensor calibration unit 140 may calibrate the output of LiDAR system 102 (e.g., calibrate the point cloud frames 166) using the edge and intensity aware techniques of this disclosure. In general, sensor calibration unit 140 perform a first edge detection process on a camera image (e.g., one camera image of camera images 168) to generate an edge detected camera image, and perform a second edge detection process on a point cloud frame (e.g., one point cloud frame of point cloud frames 166) to generate an edge detected point cloud frame. Sensor calibration unit 140 may project the edge detected point cloud frame onto the edge detected camera image using initial calibration matrix 162 and camera intrinsics 164. Initial calibration matrix 162 is a rotation and translation matrix that is used as an estimate or “starting point” for refining the calibration of LiDAR system 102. Camera intrinsics 164 include information such as focal length, scaling factors, skew factor, and other camera settings that may be used to translate a point from 3D domain (e.g., a point cloud) to a 2D domain (e.g., a camera image).

Sensor calibration unit 140 may then determine a value of an objective function representing an overlap of points in the edge detected point cloud frame and corresponding edge values in the edge detected camera image, and determine final calibration matrix 170 based on the value of the objective function. For example, sensor calibration unit 140 may determine final calibration matrix 170 by optimizing the value of the objective function. Final calibration matrix 170 is a rotation and translation matrix that may be applied to future capture point cloud frames to better align features in the point cloud frames with features in camera images.

The calibrated point cloud frames and camera images may be used in applications such as depth estimation, object detection, and/or pose detection, including the detection and recognition of objects, such as other vehicles, pedestrians, traffic signs, and lane markings. Dense or sparse depth estimation may be relatively important to a variety of applications, such as autonomous driving, assistive robotics, augmented reality, virtual reality scene composition, image editing, and/or the like. For example, in an autonomous driving scenario, depth estimation may provide an estimated distance from one vehicle to another, which may be important to operational systems of the first vehicle, for existence, acceleration, braking, steering, etc.

Monocular depth estimation has increased in popularity lately for various reasons. Stereo camera setups are relatively costly and may be relatively difficult to keep calibrated. Multi-view camera setups may suffer from a high baseline cost, synchronization issues, the existence of low overlapping regions, etc. However, monocular cameras are ubiquitous in certain industries, such as the auto industry. For example, monocular cameras can be used to collect data in the form of simple dashcams. In some examples, camera 104 includes a monocular camera.

The techniques of this disclosure may also be performed by external processing system 180. That is, the cross-sensor calibration techniques of this disclosure may be performed by a processing system that does not include the various sensors shown for processing system 100. Such a process may be referred to as an “offline” calibration process, where final calibration matrix 170 is determined from a set of test point clouds and test images received from processing system 100. External processing system 180 may then output final calibration matrix 170 to processing system 100 (e.g., an ADAS or vehicle). Such an “offline” calibration process may be performed in a manufacturing setting.

External processing system 180 may include processor(s) 190, which may be any of the types of processors described above for processor(s) 110. Processor(s) 190 may include sensor calibration unit 194 that is configured to perform the same processes as sensor calibration unit 140. Processor(s) 190 may acquire point cloud frames 166 and camera images 168 directly from LiDAR system 102 and camera 104, respectively, or from memory 160. Though not shown, external processing system 180 may also include a memory that may be configured to store point cloud frames, camera images, a final calibration matrix, an initial calibration matrix, and camera intrinsics, among other data that may be used in the calibration process.

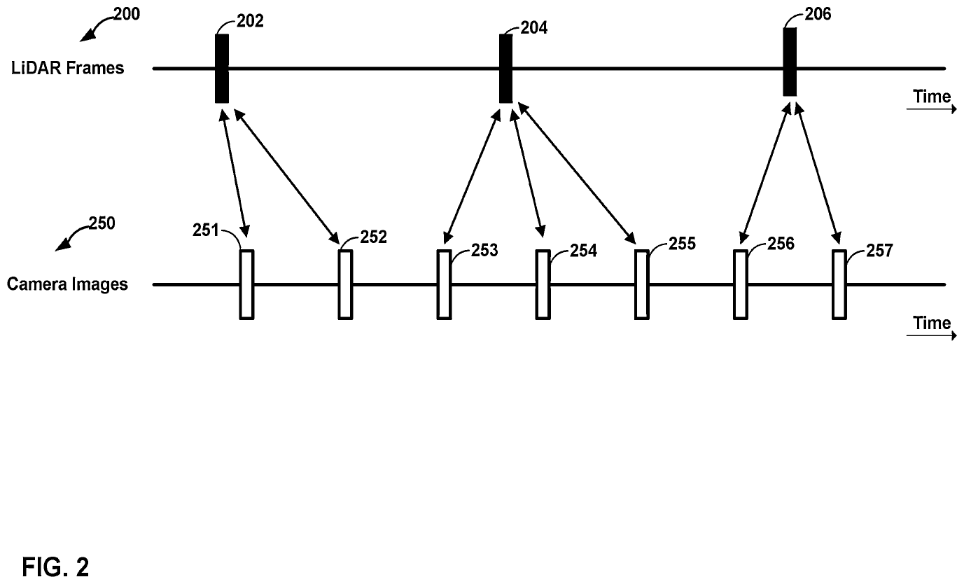

Additional details describing the cross-sensor calibration techniques of this disclosure are described below with reference to FIGS. 2-10. As discussed above, sensors such as camera 104 and LiDAR system 102 are often sources of information for different robotic applications, like autonomous vehicles. However, it is often the case that cameras and LiDAR sensor are not always running at the same frequency and might not be synchronized. For example, in some applications, a camera may be configured to capture images at a frame rate of 29 HZ, while a LiDAR sensor captures point cloud frames using a 360-degree scan at 10 Hz. As such, point cloud frames and camera images may rarely be captured at the same time. This difference in time may add to a lack of alignment between camera images and point cloud frames when such data is captured in a moving vehicle.

In some examples, cross-sensor calibration has been performed as a manual process and is hence prone to errors. While calibration techniques have improved, some applications (e.g., monocular depth estimation) perform best with extremely precise calibration of sensors. Examples of manual cross-sensor calibration techniques include target-based methods. Such methods use a predefined target object that is captured by both the camera and the LiDAR sensor. Such predefined target objects may include checkboards, cardboards with and without circles, ArUco markers, fractals, and other patterns. An ArUco marker is square-shaped, with a black border and a binary pattern inside. The binary pattern encodes a unique identifier for each marker, making it possible for a computer vision system to recognize and track multiple markers simultaneously. The black border helps to segment the marker from its surroundings and makes it more detectable.

Other example cross-sensor calibration techniques may include targetless methods, such as deep-learning based methods and computer vision-based methods. Deep-learning methods have largely been unacceptable as they require supervision and training, which may be overly costly. Computer vision-based methods rely on attempts to identify patterns in data from various sensors and matching those patterns against each other. Such patterns may include mutual information, histograms, etc. Such techniques have generally lacked the accuracy needed for all application.

In view of the cost and inaccuracy of the example cross-sensor calibration techniques described above, this disclosure describes an automatic technique for cross-sensor calibration that uses edge detection in both camera images and point cloud frames to determine a transformation between a camera and LiDAR sensor. While the techniques of this disclosure will be described with reference to a 2D photographic camera, the techniques of this disclosure may be applied to the outputs of other sensors that capture information at a higher frame rate than a LiDAR sensor, including a sonar sensor, a radar sensor, an infrared camera, and/or a time-of-flight (ToF) camera.

One problem when trying to calibrate a LiDAR sensor to a camera is that pixel level accuracy is difficult to achieve due to the lack of time synchronization between the point cloud frames output by a LiDAR sensor and the camera images output by a camera. In one example, a camera may capture images at 29 Hz, while a LiDAR sensor captures point cloud frames using a 360-degree scan at 10 Hz. Of course, different cameras and LiDAR systems may capture point clouds and images at different frame rates. However, it is often the case that cameras capture images at a faster frame rate than LiDAR sensors.

FIG. 2 illustrates an example of differing time synchronizations in camera and LiDAR systems. As shown in FIG. 2, LiDAR frames 200 (e.g., point cloud frames) are captured at a slower frame rate than camera images (e.g., camera images) 250. For depth estimation and other use cases, a point cloud frame may be aligned with each image of camera images 250. For depth estimation use cases, the point cloud data aligned with the camera image may be used as ground truth data for depth estimation. That is, the depth of pixels estimated in a camera frame may be compared to the 3D position of corresponding points in the aligned point cloud frame to determine a loss function, and ultimately, the depth of pixels in the camera image.

To mitigate the amount of misalignment between camera images 250 and LiDAR frames 200 when performing the cross-sensor calibration techniques of this disclosure, processing system 100 may be configured to select a LiDAR frame 200 that was captured closest in time each of camera images 250. Processing system 100 may determine the time at which each of LiDAR frames 200 and camera images 250 were captured from a timestamp associated with each.

As shown in FIG. 2, a processing system (e.g., processing system 100) may select LiDAR frame 202 for use with both camera image 251 and 252 when performing the cross-sensor calibration process. Processing system 100 may select LiDAR frame 204 for use with camera images 253, 254, and 255 when performing the cross-sensor calibration process. Processing system 100 may select LiDAR frame 206 for use with camera images 256 and 257 when performing the cross-sensor calibration process.

In addition to a lack of time synchronization, there may be inaccuracy in spatial mapping between sensors. Cameras and LiDAR sensors are unlikely to be located in the same positions on a vehicle or other application. In addition, for vehicular use cases, a vehicle on which a LiDAR sensor is mounted (e.g., the ego vehicle), may move considerably during the capture of a point cloud frame and between subsequent captures of point cloud frames. For example, assuming a vehicle is driving at 65 mph, the ego vehicle can move up to 1.5 m in 50 ms. Given this mismatch between the timestamp of a camera image and its nearest in time LiDAR point cloud frame, there may be substantial inaccuracy in depth map or other calculations using camera images and point cloud frames that are not accurately calibrated, especially for objects that are close to the camera and the LiDAR sensor.

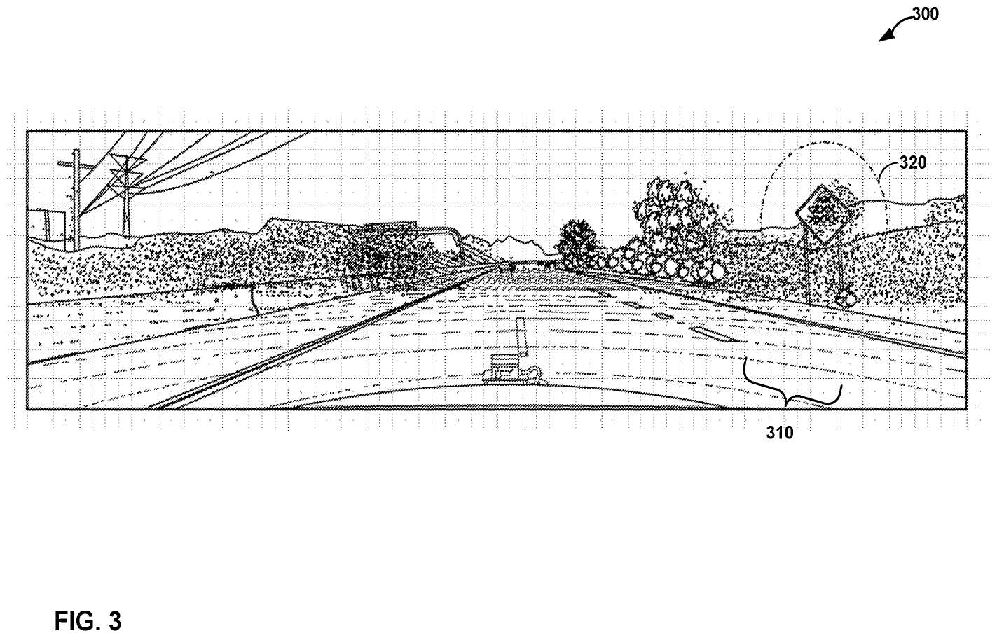

FIG. 3 is a conceptual drawing illustrating one example of a point cloud overlaid on a camera image. FIG. 3 shows an image 300 that has points 310 overlaid from a point cloud frame. As shown in the highlighted area 320, points from the point cloud frame are misaligned to the road sign.

In one example of the disclosure, to help mitigate both time and spatial synchronization issues with the capture of point cloud frames relative to camera images, processing system 100 may be configured to perform a motion compensation (e.g., called ego motion compensation in vehicular applications) on captured point cloud frames.

Ego motion compensation refers to the process of accounting for and correcting the motion of a moving sensor (e.g., a LiDAR sensor) in order to obtain more accurate information about the surrounding environment. One goal of ego motion compensation is to eliminate the effects of the sensor's own motion, so that the relative motion of the surrounding objects can be correctly estimated. In some examples, ego motion compensation typically involves the estimation of ego motion and the transformation of captured data (e.g., point cloud frames). The estimation of ego motion may include determining the LiDAR sensor's own motion parameters, such as position, orientation (e.g., pose), and velocity, using various sensors like accelerometers, gyroscopes, and GPS. Once the ego motion is estimated, the captured data (e.g., the point cloud frame) is transformed to compensate for the LiDAR sensor's motion. This is done by applying geometric transformations, such as rotation and translation, to the data so that it appears as if it were captured from a stationary viewpoint.

Ego motion compensation generally works well for static objects in a scene (e.g., signs, vegetation, guard rails, lane markers, buildings, etc.). As most objects in a scene captured by a camera or LiDAR sensor are static, ego motion compensation may be used together with the edge detection techniques described below to perform cross-sensor calibration.

The following describes one example of performing the cross-sensor calibration techniques of this disclosure. This example may be referred to as an “offline” calibration technique, as the following process uses a data set of already captured camera images and point cloud frames captured by the camera and LiDAR sensor being calibrated. In one example, to a number of equally distanced samples (e.g., 150) from a given data set of camera images and point cloud frames are selected. The processing system 100 may apply a search window around each of these samples to find point cloud frames that were captured nearest in time to a camera image. For example, processing system may determine a point cloud frame from a plurality of point cloud frames in the data set, including selecting the point cloud frame that was captured closest in time to the camera image (e.g., based on a timestamp). By selecting camera image and point cloud frames pairs captured nearest in time, the impact of ego motion compensation for dynamic objects (e.g., non-static objects) in the scene is lessened.

Once processing system 100 determines the point cloud frame and camera image pair, processing system 100 may be configured to perform an edge detection process on each. First, processing system 100 may perform a first edge detection process on the camera image to generate an edge detected camera image. Processing system 100 may use any edge detection algorithm to perform the first edge detection process. Example, edge detection algorithms may include Canny edge detection, Sobel operators, Prewitt operators. Laplacian of Gaussian filters, and others. The edge detection process may be performed on either a grayscale image or a color (e.g., RGB image).

Canny edge detection is a multi-stage process that involves several steps, such as noise reduction using Gaussian filtering, gradient magnitude and direction calculation, non-maximum suppression to thin out the edges, and hysteresis thresholding for edge linking and tracking. The Canny algorithm is generally useful for its ability to produce clean and well-defined edges while being relatively robust to noise.

The Sobel operator is a gradient-based method that uses two separate 3×3 convolution kernels (one for horizontal edges and one for vertical edges) to compute the approximated gradient magnitudes of the image. The gradient magnitudes are then thresholded to identify the edge points. The Sobel operator is known for its simplicity and relatively low computational cost, making it suitable for real-time applications.

Similar to the Sobel operator, the Prewitt operator uses two 3×3 convolution kernels for detecting horizontal and vertical edges. However, the Prewitt operator uses simpler kernels, which do not emphasize diagonal edges as much as the Sobel operator.

The Laplacian of Gaussian (LoG) process involves first applying a Gaussian filter to smooth the image and reduce noise, followed by computing the Laplacian, which is a second-order derivative to highlight the zero-crossing points that correspond to the edges. LoG is more accurate in detecting edges but has a higher computational cost compared to gradient-based techniques like Sobel and Prewitt operators.

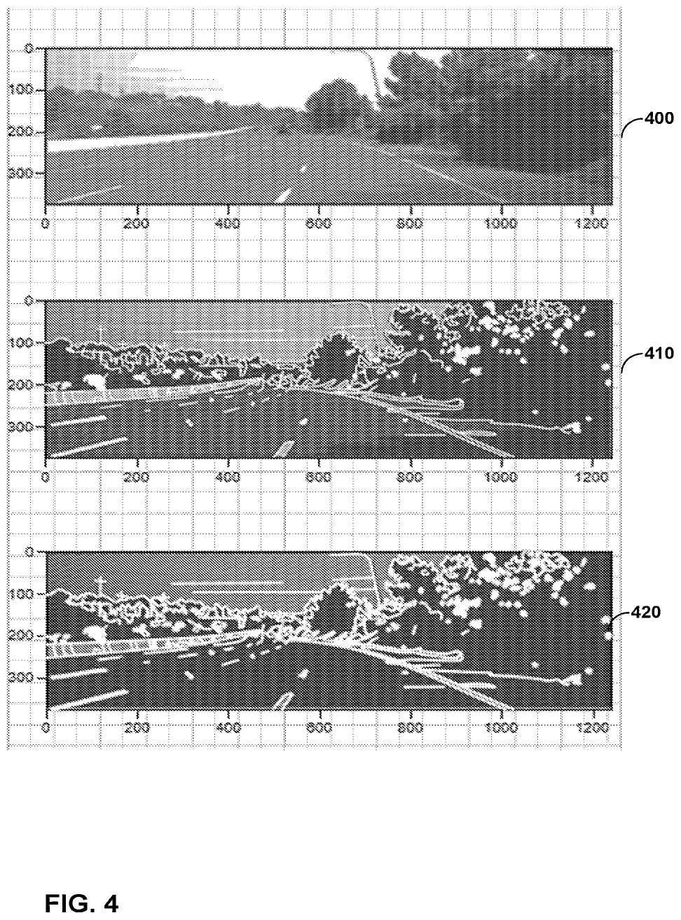

FIG. 4 is a conceptual drawing illustrating example outputs of a camera edge detection process for the cross-sensor calibration of the disclosure. FIG. 4 shows an input grayscale camera image 400. Edge detected camera image 410 shows the result of applying an edge detection process as described above.

In addition to the edge detection process, processing system 100 may be configured to perform a filtering process on the edge detected camera image 410 to smooth one or more edges in the edge detected camera image 410. A smoothed edge detected camera image 420 is shown in FIG. 4.

The smoothing filter generally blurs out the edges to create wider edges in the edge detected camera image. This allows for easier correlation between the edges detected in the camera image and edges detected in the point cloud frame.

The following describes some example smoothing filters that may be used:

Gaussian Filter: The Gaussian filter is a smoothing function that applies a Gaussian distribution as a convolution kernel to the image. The Gaussian function blurs the image equally in all directions. The Gaussian function may be particularly effective for noise reduction and produces natural-looking blurred edges. The Gaussian function standard deviation (o) controls the extent of the blur.

Mean Filter (Box Filter): The mean filter is a smoothing function that replaces each pixel's value with the average value of its neighboring pixels. The filter's size (e.g., 3×3, 5×5) determines the degree of blurring.

Median Filter: The median filter is a non-linear smoothing function that replaces each pixel's value with the median value of its neighboring pixels. This method is effective in removing noise while preserving edges. Median filters are particularly useful for reducing noise from edge detection algorithms that are sensitive to noise.

Bilateral Filter: The bilateral filter is an advanced smoothing function that combines domain and range filtering to preserve edges while smoothing the image. The filter takes into account both the spatial closeness and the intensity similarity between pixels. This helps maintain sharp edges while still reducing noise. Bilateral filters are computationally more expensive than other smoothing functions but offer superior edge preservation.

Guided Filter: The guided filter is an edge-preserving smoothing function that uses an additional guidance image to control the amount of smoothing applied to the input image. This filter can adaptively smooth flat regions while preserving edges and textures. The Guided filter is particularly useful for refining edge maps obtained from edge detection algorithms, as it can suppress false edges while preserving true edges.

These smoothing functions can be used individually or combined in a multi-stage process to achieve the desired level of noise reduction and edge preservation. The choice of smoothing function depends on the specific requirements of the application and the trade-offs between performance and computational complexity. The size of the region of the image (e.g., the patch) used for smoothing may vary depending on hardware capability. For example, a 121×121 patch may be used with a GPU while an 11×11 patch may be used with a CPU.

Processing system 100 may be further configured to perform a second edge detection process on the point cloud frame to generate an edge detected point cloud frame. To perform the second edge detection process on the point cloud frame, processing system 100 may be configured to filter points which belong to edges by calculating the distance gap between neighboring points for any given LiDAR point and removing points that exceed a threshold distance from neighboring points. In one example, only horizontal neighbors are considered, since the LiDAR sensor typically beam scans horizontally.

In addition to distance-based point filtering to identify edges, processing system 100 may also consider intensity or reflectance values of points to determine edges. For example, processing system 100 may include points the edge detected point cloud frame that have high intensity compared to a threshold. For example, points belonging to lane markers, road signs, license plates, and other physical objects tend to have high intensity and would likely contribute to missed edge points.

As part of the second edge detection process, to determine the points to include in the edge detected point cloud frame, processing system 100 may weight each point based on the points “edginess” (e.g., the magnitude of distance gap between the point and its neighbors), a scaled version of the points intensity/reflectance, or a combination of both. Processing system 100 may use one or more tunable threshold values to determine which magnitudes of distance gaps and/or intensity values are indicative that a point in the point cloud frame belongs to an edge.

After performing the edge detection processes on both the camera image and the point cloud frame, processing system 100 may project the edge detected point cloud frame onto the edge detected camera image using an initial calibration matrix C. The initial calibration matrix C is a rotational and transformation transform that maps the location of points in the edge detected point cloud frame to pixels in the edge detected camera image. Processing system 100 may also use one or more camera intrinsics values of a camera used to capture the camera image to project the edge detected point cloud frame onto the edge detected camera image. Camera intrinsics values may include information such as focal length, scaling factors, skew factor, and other camera settings that may be used to translate a point from 3D domain (e.g., a point cloud) to a 2D domain (e.g., a camera image). The initial calibration matrix C may be a manually determined or estimated rotation and transformation matrix. In effect, initial calibration matrix C is a starting point for refinement to produce a final calibration matrix.

In some examples, the initial calibration matrix and the final calibration matrix is a translation and rotation matrix, such as a 6 degrees-of-freedom (6DOF) matrix. In other examples, the initial calibration matrix and the final calibration matrix is a 3×4 transformation matrix.

A 6DOF matrix represents the translation and rotation of an object in a three-dimensional space. The 6DOF allows the object to move and rotate along the three Cartesian coordinate axes (X, Y, and Z). In some examples, the 6DOF matrix is a 4×4 homogeneous transformation matrix that combines the translation and rotation components into a single matrix for more efficient calculations.

The general form of a 6DOF matrix is as follows:
   |R11 R12 R13 Tx|
   |R21 R22 R23 Ty|
   |R31 R32 R33 Tz|
   |0 0 0 1|

Here, R11-R33 represent the rotation matrix (also known as the orientation matrix), which is a 3×3 matrix that describes the object's rotation around the X, Y, and Z axes. The rotation matrix can be derived from various representations, such as Euler angles, axis-angle, or quaternions.

Tx, Ty, and Tz represent the translation components along the X, Y, and Z axes, respectively.

The last row (0, 0, 0, 1) is a constant row that enables the use of homogeneous coordinates, which simplifies the mathematical operations involved in transformations like translation, rotation, and scaling. In some examples, the last row is not used.

Using this 6DOF matrix, processing system 100 can transform a point in the edge detected point cloud frame to its corresponding position in edge detected camera image by performing matrix-vector multiplication.

A 3×4 transformation matrix is used to represent an affine transformation in 3D space, which includes rotation, translation, and scaling (uniform or non-uniform). The matrix has 3 rows and 4 columns, and its structure is as follows:
   |a b c Tx|
   |d e f Ty|
   |g h i Tz|

Here, the 3×3 submatrix formed by the elements a-i represents the linear transformation part (rotation and scaling). Tx, Ty, and Tz represent the translation components along the X, Y, and Z axes, respectively.

After projecting the edge detected point cloud frame onto the edge detected camera image, the processing system may determine a value of an objective function representing an overlap of points in the edge detected point cloud frame and corresponding edge values in the edge detected camera image. The higher the value of the objective function, the better overlap between the edge detected point cloud frame and the edge detected camera image, thus indicating a more accurate cross-sensor calibration.

In effect, processing system may determine a final calibration matrix by applying a numerical optimization process to an objective function. A numerical optimization process is a mathematical technique used to find the optimal solution or the best possible value of a given objective function, subject to certain constraints.

In a numerical optimization process, the objective function is a mathematical representation of a problem's goal, which can be either maximized (e.g., maximizing profit or efficiency) or minimized (e.g., minimizing cost or error). In this case, the objective function represents the amount of overlap between the edge detected point cloud frame and the edge detected camera image. So, in this case, the numeral optimization process seeks to maximize the value of the objective function.

Numerical optimization techniques can be broadly categorized into two types: deterministic and stochastic methods. Deterministic methods are based on well-defined mathematical rules and converge to a specific solution or a set of solutions. Examples of deterministic methods include:
Gradient Descent: A first-order optimization algorithm that iteratively moves towards the direction of the steepest descent (negative gradient) to find the minimum of the objective function.
Newton's Method: A second-order optimization algorithm that uses the objective function's gradient and Hessian matrix (second derivatives) to find the minimum or maximum more rapidly than gradient descent.
Simplex Method: A widely-used algorithm for linear programming problems that iteratively moves along the vertices of a feasible region to find the optimal solution.

Stochastic methods incorporate random processes and probabilistic elements to explore the solution space, which can be helpful in escaping local optima and finding global optima. Examples of stochastic methods include:
Genetic Algorithms: Optimization techniques inspired by the process of natural selection, where a population of candidate solutions evolves over time through operations like mutation, crossover, and selection.
Simulated Annealing: A probabilistic optimization algorithm inspired by the annealing process in metallurgy, where the solution is progressively refined by randomly exploring the search space while gradually reducing the acceptance probability of worse solutions.
Particle Swarm Optimization: A population-based optimization algorithm that simulates the social behavior of a swarm of particles, where each particle updates its position based on its personal best solution and the swarm's global best solution.

The choice of a numerical optimization method depends on the nature of the objective function, the constraints, and the desired level of solution accuracy. Some problems may benefit from a combination of deterministic and stochastic methods to achieve an optimal balance between exploration and exploitation.

In one example of the disclosure, to determine the objective function, processing system 100 may calculate a respective products of respective magnitudes of the points in the edge detected point cloud frame and respective corresponding edge values in the edge detected camera image. That is, processing system may iterate over all filtered 3D LiDAR points projected onto the edge detected camera image and calculating the product of the filtered LiDAR point's magnitude and the corresponding camera image edge value at the 2D location of the LiDAR point. In this example, the edge value is the grayscale value, where the grayscale value may range from 0 to some maximum value (e.g., 255). An accurate overlap between the LiDAR edges and the camera edges would give a high objective function.

As discussed above the points in the point cloud frame are filtered to determine edge. The points may be filtered based on distance-based edge detection and/or intensity based edge detection. Therefore, a point may be included in the edge detected point cloud frame (and thus projected onto the edge detected camera image) if a point has a certain depth, compared to a threshold, that is greater than its neighbor. A point may also be included in the edge detected point cloud frame (and thus projected onto the edge detected camera image) if the point has an intensity (e.g., reflectance) greater than its neighbor compared to a threshold. As such, the points ‘magnitude’ used in computing the objective function above can be either 1) scale*(depth of point−depth of neighbor) or 2) scale*(intensity of point−intensity of neighbor), where scale is a scale factor. Example thresholds and scale values are described below.

Threshold and scales for LiDAR edges. In the below, the variable “Lidar_edge” is the magnitude of the point in the edge detected point cloud frame.
a. Distance based edge:
   dist_edge=(depth_neighbor−depth_pt)^{0.5}
      if dist_edge>=2.5:
         i. Lidar_edge=dist_edge
b. Intensity based edge:
   If the above is not satisfied, intensity based edge is checked.
   intensity_edge=intensity_pt−intensity_neighbor
   if intensity_edge>=70:
      i. Lidar_edge=intensity_edge/10
         If none of the above conditions are met, then Lidar_edge=0 at that pixel location.

In the above, depth_neighbor depth of a neighbor point to the current point, depth_pt is the depth of the current point, intensity_pt is the intensity of the current point, and intensity_neighbor is the intensity of a neighbor point to the current point. Dist_edge and intensity_edge are intermediate values used to determine the value of Lidar_edge.

Processing system 100 may find a final calibration matrix C that results in the highest objective function using one or more of the numerical optimization processes described above. In general, processing system 100 may optimize the value of the objective function to determine a final calibration matrix. Processing system 100 may perform an iterative process that includes updating the initial calibration matrix C to form an updated calibration matrix C. Processing system 100 may then reproject the edge detected point cloud frame onto the edge detected camera image using the updated calibration matrix C. Processing system 100 may then determine a new, updated value of the objective function representing the overlap of points in the edge detected point cloud frame and corresponding edge values in the edge detected camera image.

Processing system 100 may compare the updated value of the objective function to one or more prior values of the objective function. If the change of updated value of the objective function compared to prior values of the object function is less than a predetermined threshold, this may indicate that no further optimization of the objective function is possible. As such, processing system 100 may output the calibration matrix associated with the largest value of the objective function as the final calibration matrix.

If the change of updated value of the objective function compared to prior values of the object function is not less than a predetermined threshold, processing system 100 may generate a second updated calibration matrix, and reproject the edge detected point cloud frame onto the edge detected camera image using the second updated calibration matrix. A new objective function is then determined. This process is iterated until the objective function has been optimized. The calibration matrix that was used to achieve the optimized value of the objective function is used as the final calibration matrix.

In some examples, the numerical optimization process is used to determine the highest value of the objective function, and thus the final calibration matrix may be a genetic algorithm, and may be implemented using a PyTorch optimization flow. PyTorch is an open-source machine learning library that is used for deep learning and artificial intelligence applications, such as natural language processing, computer vision, and reinforcement learning.

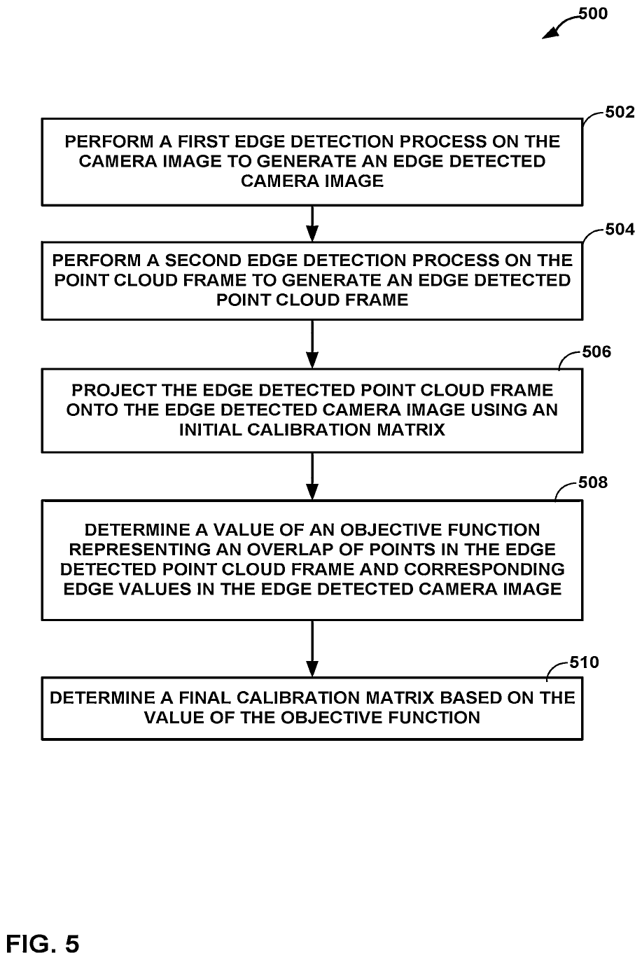

FIG. 5 is a flowchart illustrating one example process 500 for cross-sensor calibration of the disclosure. The techniques of FIG. 5 will be described with reference to sensor calibration unit 140 of FIG. 1. However, the techniques of FIG. 5 may be performed by either processing system 100 and/or external processing system 180, including sensor calibration unit 194.

In one example of the disclosure, sensor calibration unit 140 may be configured to perform a first edge detection process on the camera image to generate an edge detected camera image (502), and perform a second edge detection process on the point cloud frame to generate an edge detected point cloud frame (504). Sensor calibration unit 140 may also project the edge detected point cloud frame onto the edge detected camera image using an initial calibration matrix (506). Sensor calibration unit 140 may then determine a value of an objective function representing an overlap of points in the edge detected point cloud frame and corresponding edge values in the edge detected camera image (508), and determine a final calibration matrix based on the value of the objective function (510).

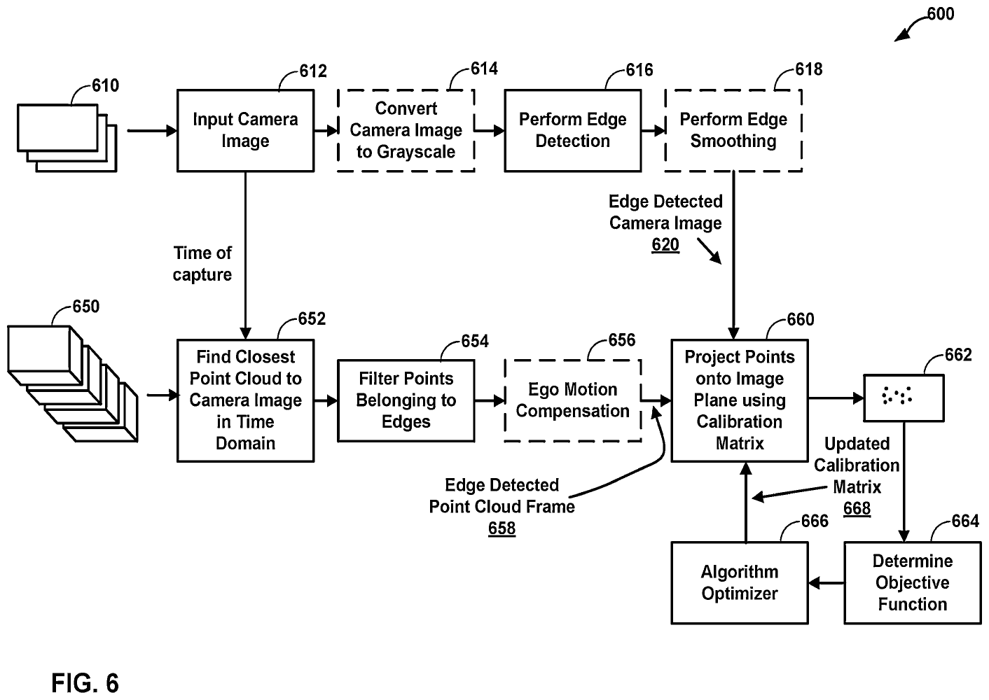

FIG. 6 is a flow diagram illustrating another example process 600 for cross-sensor calibration of the disclosure. In general, FIG. 6 is one example of a more detailed process than the general process of FIG. 5. Again, the techniques of FIG. 6 will be described with reference to sensor calibration unit 140 of FIG. 1. However, the techniques of FIG. 6 may be performed by either processing system 100 and/or external processing system 180, including sensor calibration unit 194.

As shown in FIG. 6, sensor calibration unit 140 may receive a plurality of camera images 610 and a plurality of point cloud frames 650. At 612, sensor calibration unit 140 receives an input camera image. At 652, sensor calibration unit 140 finds the closest point cloud frame, from point cloud frames 650, to the input camera image in the time domain. Sensor calibration unit 140 may determine the point cloud frame using the time of capture (e.g. timestamp) of the input camera image.

In an optional step, at 614, sensor calibration unit 140 may convert the camera image to grayscale. In some examples, the camera image may already be in grayscale. In other examples, the process 600 may be performed on color images. At 616, sensor calibration unit 140 may perform a first edge detection process on the camera image to generate an edge detected camera image. Sensor calibration unit 140 may use any of the edge detection techniques described above.

At 618, sensor calibration unit 140 may optionally perform a filtering process on the edge detected camera image to smooth one or more edges in the edge detected camera image. In other examples, the edge smoothing may be skipped or may be performed as part of the edge detection process (616). Sensor calibration unit 140 may use any of the edge smoothing techniques described above. The output after edge smoothing, if performed, is edge detected camera image 620.

At 654, sensor calibration unit 140 may perform a second edge detection process on the point cloud frame to generate an edge detected point cloud frame. That is, sensor calibration unit 140 may filter points in the point cloud frame that belong to edges. Optionally, at 656, sensor calibration unit 140 may perform a motion compensation process on the edge detected point cloud frame. For example, sensor calibration unit 140 may perform ego motion compensation as described above. In applications where the camera and LiDAR sensor are expected to be static, the ego motion compensation process may be skipped. Ego motion compensation may be most beneficial for mobile applications, such as vehicles and ADAS. After ego motion compensation, if performed, the output is edge detected point cloud frame 658.

At 660, sensor calibration unit 140 projects edge detected point cloud frame 658 onto edge detected camera image 620 using an initial calibration matrix to produce projected image 662. In some examples, sensor calibration unit 140 may project edge detected point cloud frame 658 onto edge detected camera image 620 using the initial calibration matrix and one or more camera intrinsics values of a camera used to capture the camera image.

At 664, sensor calibration unit 140 determines a value of an objective function representing an overlap of points in edge detected point cloud frame 658 and corresponding edge values in edge detected camera image 620 present in projected image 662. In one example, to determine the value of the objective function, sensor calibration unit 140 may calculate respective products of respective magnitudes of the points in the edge detected point cloud frame and respective corresponding edge values in the edge detected camera image.

At 666, sensor calibration unit 140 applies an algorithm optimizer to perform an iterative numerical optimization process on the objective function, as described above. The algorithm optimizer may include generating an updated calibration matrix 668, reprojecting the edge detected point cloud, and recomputing the objective function. For example, sensor calibration unit 140 may update the initial calibration matrix to form an updated calibration matrix 668, reproject edge detected point cloud frame 658 onto edge detected camera image 620 using updated calibration matrix 668, determine an updated value of the objective function representing the overlap of points in the edge detected point cloud frame and corresponding edge values in the edge detected camera image, and output the updated calibration matrix as the final calibration matrix based on a comparison of the updated value of the objective function to one or more prior values of the objective function.

In other examples of the disclosure, at 664 when determining the value of the objective function, sensor calibration unit may apply weights to points in the edge detected point cloud frame 658 based on respective distances of the points in the edge detected point cloud frame relative to a center of the edge detected camera image, and/or based on respective angles of the points in the edge detected point cloud frame relative to a feature in the camera image. In general, such weights may be used to lessen the influence of points that are not representative of useful edges, including points representative of vegetation or points representative of objects behind the LiDAR sensor.

Vegetation, including trees and bushes, generally introduce a high number of edges in the LiDAR point cloud, as there are a lot of variations in their surface. The large volume of such edges may not be beneficial in use cases and may skew the calibration. As such, in some examples when computing the objective function, sensor calibration unit 140 may be configured to exclude or down weight points associated with vegetation.

In one example, sensor calibration unit 140 may use color values in the camera image vicinity of point cloud points to filter out vegetation-related points. For example, points that overlap with pixels having a greenish tone may be de-weighted or removed. In this case, de-weighting may include applying a weighting value under 1 to the intensity value of the point.

In another example, sensor calibration unit 140 may use the density of the edge points in a vicinity to determine if such points are associated with vegetation. In general, points for edges detected for vegetation may have a higher density than edges detected for other objects. The higher the density the lower the weight of the edge in objective function.

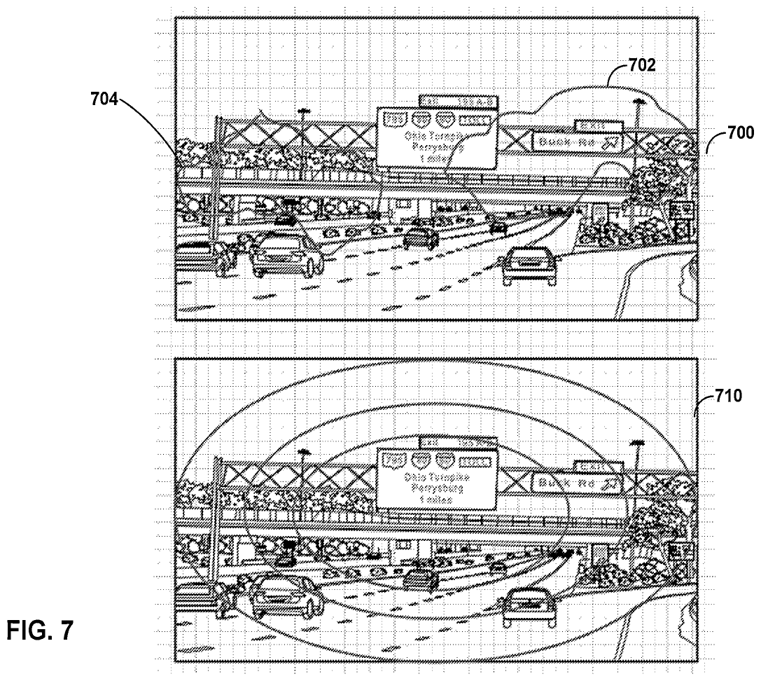

FIG. 7 is a conceptual diagram illustrating two example techniques for de-weighting vegetation in edge detected point cloud frames for the cross-sensor calibration of the disclosure. In image 700, outlined areas 702 and 704 have a higher density of points detected as being edges, thus possibly indicating the presence of vegetation. Sensor calibration unit 140 may also use the size/magnitude of the edge to determine areas of vegetation to de-weight, as edges representative of vegetation typically have smaller edges.

In another example, sensor calibration unit 140 may use the distance of a pixel, in 2D camera frame, from the center to determine when to de-weight projected points. Image 710 in FIG. 7 shows concentric ovals around the center of the image. Each oval band may represent a different weight, where the weight gets smaller as the bands move away from the center of the image. Such a distance based weighting scheme may work well in many situations as vegetation is typically not in in the middle of the road in front of the ego vehicle, but is rather to the side.

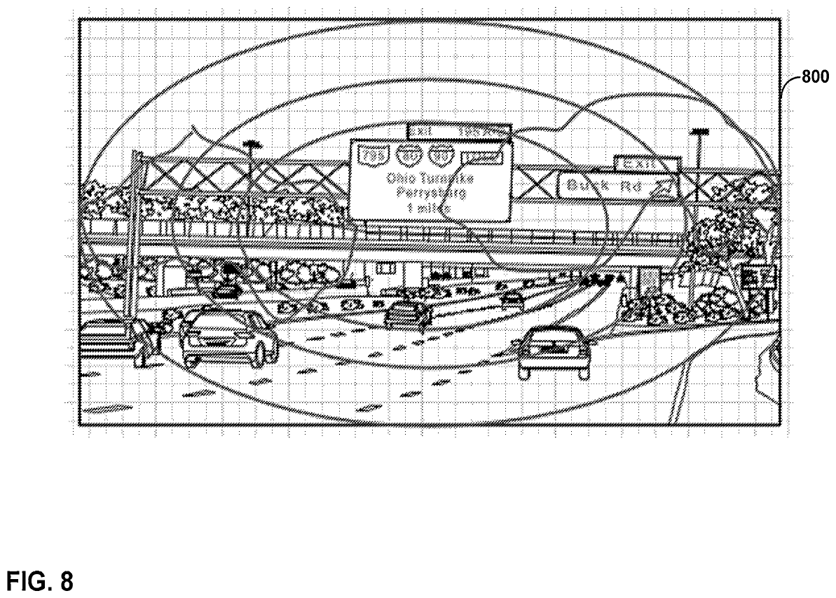

In other examples, sensor calibration may use a combination of density of edges and distance from the center of the camera image to determine weights for de-weighting points from the point cloud associated with vegetation. FIG. 8 is a conceptual diagram illustrating another example technique for de-weighting vegetation in edge detected point cloud frames for the cross-sensor calibration of the disclosure. In FIG. 8, image 800 shows the application of both edge density and distance.

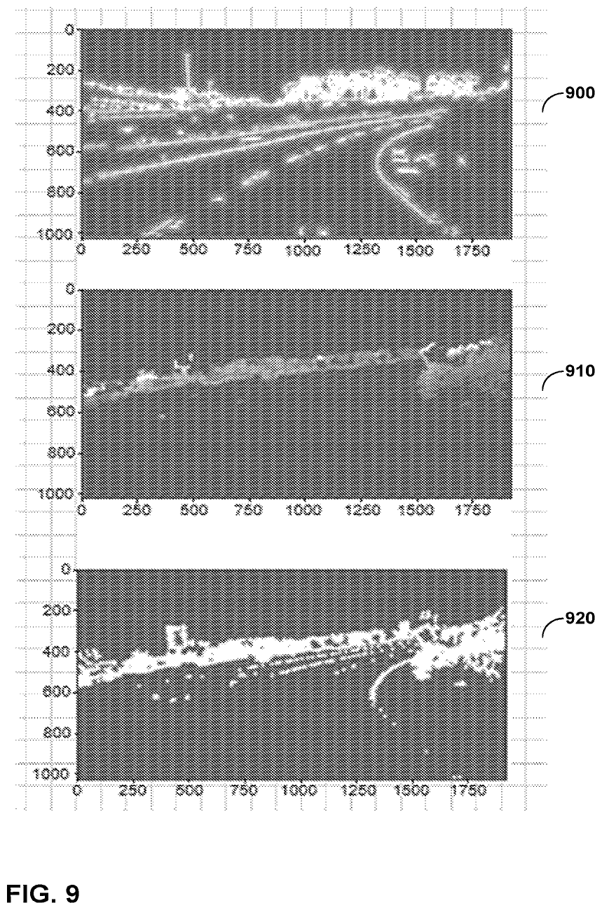

In other examples of the disclosure, sensor calibration unit 140 may be configured to de-weight or remove points from determining the value of the objective function if such points are due to LiDAR drifting (e.g., are points from the side or behind the ego vehicle and are not representative of objects in the camera image. As described above, a typical LiDAR sensor performs a rotating. 360-degree scan around the ego vehicle. In some situations, points from the side and rear of the vehicle may be included as edge points projected onto the edge detected camera frame, as sometimes such points might give slightly better numerical value. However, such, points are unlikely to represent actual matches with objects in the camera frame. In this case, sensor calibration unit 140 may be configured to weight (e.g., de-weight) and/or remove points based on respective angles of the points in the edge detected point cloud frame relative to a feature in the camera image. FIG. 9 is a conceptual diagram illustrating an example technique for de-weighting certain points in edge detected point cloud frames for the cross-sensor calibration of the disclosure. Image 900 shows an example camera image that has been converted to grayscale, has been edge detected, and has had a smoothing filter applied. Image 910 shows an edge detected point cloud frame (e.g., detected based on depth) projected onto a 2D camera image. Image 920 shows an edge detected point cloud frame (e.g., detected based on depth and intensity using the weighting function described above) and then projected onto a 2D camera image.

Testing has shown that the cross-sensor calibration techniques of this disclosure have provided for a qualitative improvement over other calibration techniques. The technique describe above has been evaluated using a set real-world frames collected by ego vehicles using both cameras and LiDAR sensors. Cross-sensor calibration was improved noticeably under various driving scenarios, weather, and lighting conditions.

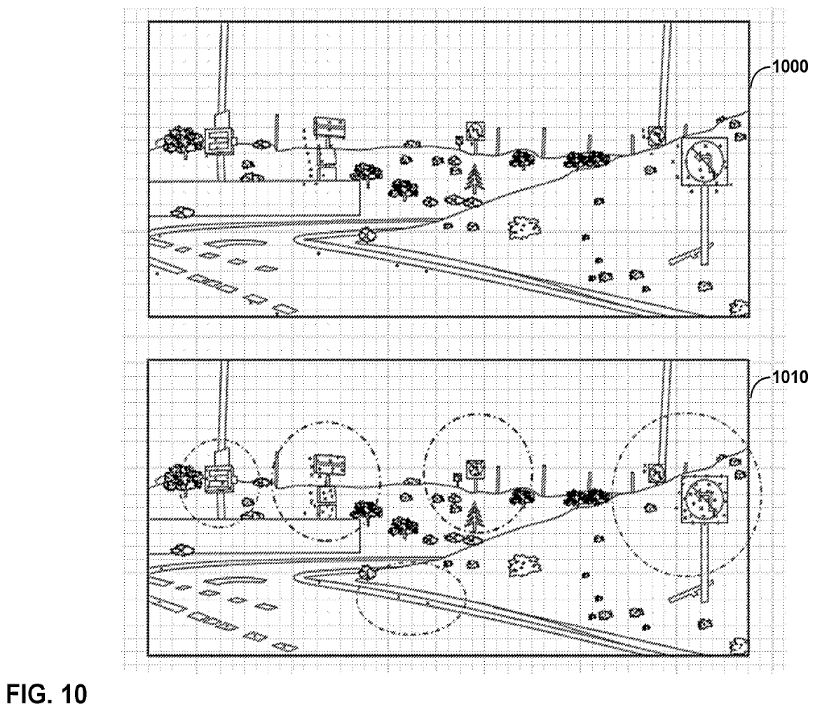

FIG. 10 is a conceptual diagram showing an example output using the cross-sensor calibration techniques of this disclosure. FIG. 10 shows an image 1000 with an example of projected point cloud points calibrated using prior, manual techniques. As shown in image 1000, points do not always align with real word objects, such as lane markers and signs. Image 1010 shows an example projected point cloud points calibrated to the image using the techniques of this disclosure. As highlighted in the dashed circles, the projected points more closely match the real-world objects compared to image 1000.

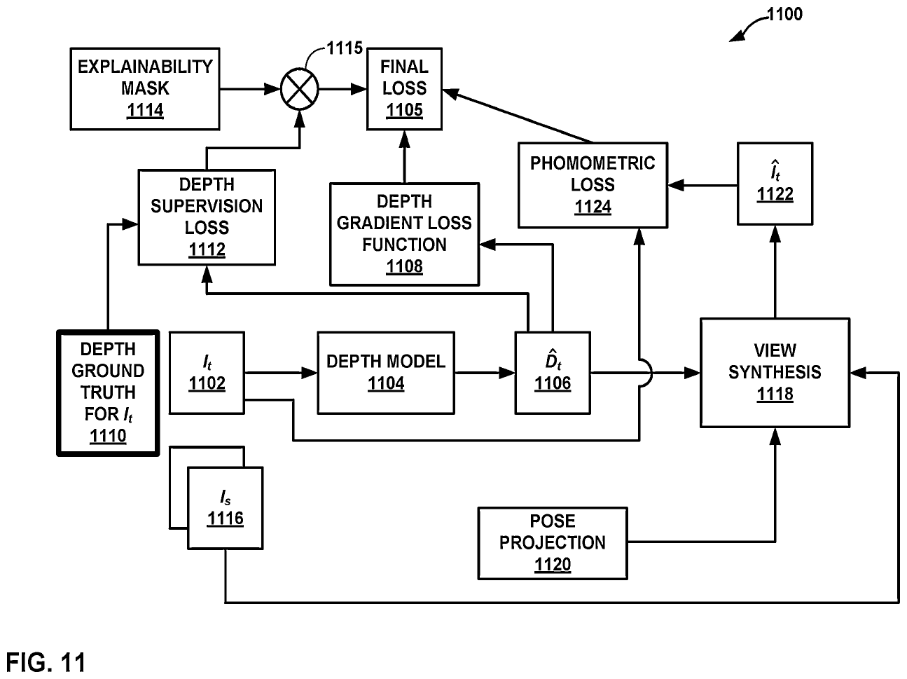

To numerically evaluate the improvement in the calibration quality, point clouds calibrated using the final calibration matrix produced by the techniques of this disclosure were used in a depth estimation system (e.g., as described in FIG. 11 below). The example depth estimation system uses partial supervision with ground truth coming from LiDAR point clouds calibrated using the techniques of this disclosure. The improvement in the quality of depth estimation results were achieved with no additional inference time, complexity, power, or memory compared to other techniques whereby LiDAR point clouds were calibrated manually.

In Table 1 below, the absolute relative error (Abs rel), squared relative error (Sq rel), root mean squared error (RMSE), and the RMSE log are shown when comparing an estimated depth to the actual ground truth depth of a point cloud calibrated using a manual process or the automatic, edge detection-based techniques of this disclosure. As seen in Table 1, the Abs rel, Sq rel, RMSE and RSE log values are all improved (i.e., lowered) when compared to manually calibrated point clouds. A1 shows the percentage of pixels in the predicted depth map which differ with respect to the ground truth depth by less than a factor of 1.25. A2 shows the percentage of pixels in the predicted depth map which differ with respect to the ground truth depth by less than a factor of 1.25\hat{ }2. A3 shows the percentage of pixels in the predicted depth map which differ with respect to the ground truth depth by less than a factor of 1.25\hat{ }3.

| | Abs rel | Sq rel | RMSE | RMSE log | A1 | A2 | A3 |
|---|---|---|---|---|---|---|---|
| Manual | 0.090 | 1.521 | 8.514 | 0.188 | 0.907 | 0.960 | 0.980 |
| Auto | 0.068 | 1.115 | 7.907 | 0.164 | 0.940 | 0.967 | 0.982 |

To examine the robustness of the cross-sensor calibration techniques described herein to the initial extrinsic values (e.g., the initial calibration matrix), the techniques of this disclosure were also tested using an initial calibration matrixes where all translation values are set to 0. This is a significant difference from other initial calibration matrixes, such as those generated by manual processes, where the translation values are typically around 5 cm, 80 cm, and 110 cm. It was observed that the translation values for the final calibration matrix converged to the same values, regardless of the values used in the initial calibration matrix. However, the closer the initial calibration matrix is to the optimized, final calibration matrix, the faster the process takes place.

As such, the techniques of this disclosure may be useful even when a poor estimate of the final calibration matrix is used as an initial calibration matrix. As such, the techniques of this disclosure are not only useful to calibrate sensors in an offline mode, but the techniques of this disclosure may be performed periodically performed by the processing system while the camera and LiDAR systems are in operation using only a few frames of data. Sensor calibration unit 140 may make small perturbations to the currently used final calibration matrix to see if better values may be optimized. Such “in-use” cross-sensor calibration may be useful as an ego vehicle is in operation due to movement or slight changes of positioning of the sensors.

FIG. 11 is a conceptual diagram illustrating an example training architecture for partial supervision in self-supervised monocular depth estimation. Initially, a subject frame 1102 of camera image data at time t (Iₜ) may be provided to a machine learning model 1104, such as a neural network model (referred to in some examples as “DepthNet” or a “Depth Model”). Model 1104 processes the image data and generates an estimated depth output (\hat{D}ₜ) 1106. Estimated depth output 1106 may take different forms, such as a depth map indicating the estimated depth of each pixel directly, or a disparity map indicating the disparity between pixels. Depth and disparity are related and can be proportionally derived from each other.

Estimated depth output 1106 is provided to a depth gradient loss function 1108, which determines a loss based on, for example, the “smoothness” of the depth output. In one aspect, the smoothness of the depth output may be measured by the gradients (or average gradient) between adjacent pixels across the image. For example, an image of a simple scene having few objects may have smooth depth map, whereas an image of a complex scene with many objects may have a less smooth depth map, as the gradient between depths of adjacent pixels changes frequently and significantly to reflect the many objects.

Depth gradient loss function 1108 provides a depth gradient loss component to final loss function 1105. Though not depicted in FIG. 11, the depth gradient loss component may be associated with a hyperparameter (e.g., a weight) in final loss function 1105, which may alter the influence of the depth gradient loss on final loss function 1105.

Estimated depth output 1106 is provided as an input to view synthesis function 1118. View synthesis function 1118 further takes as inputs one or more context frames (Iₛ) 1116 and a pose estimate from pose projection function 1120 and generates a reconstructed subject frame ( [symbol] ) 1122. For example, view synthesis function 1118 may perform an interpolation, such as bilinear interpolation, based on a pose projection from pose projection function 1120 and using the depth output 1106.

Context frames 1116 may generally be frames near to the subject frame 1102. For example, context frames 1116 may be some number of frames or time steps on either size of subject frame 1102, such as t+/−1 (adjacent frames), t+/−2 (non-adjacent frames), or the like. Though these examples are symmetric about subject frame 1102, context frames 1116 could be non-symmetrically located, such as t−1 and t+3.

Pose projection function 1120 is generally configured to perform pose estimation, which may include determining a projection from one frame to another.

Reconstructed subject frame 1122 may be compared against subject frame 1102 by a photometric loss function 1124 to generate a photometric loss, which is another component of final loss function 1105. As discussed above, though not depicted in the figure, the photometric loss component may be associated with a hyperparameter (e.g., a weight) in final loss function 1105, which changes the influence of the photometric loss on final loss function 1105.

Estimated depth output 1106 is further provided to depth supervision loss function 1112, which takes as a further input estimated depth ground truth values for subject frame 1102, generated by depth ground truth for Iₜ function 1110, in order to generate a depth supervision loss. In general, the output of depth ground truth for It function 1110 is a sparse point cloud depth map used as a ground truth.

In some aspects, depth supervision loss function 1112 only has or uses estimated depth ground truth values for a portion of the scene in subject frame 1102, thus this step may be referred to as a “partial supervision”. In other words, while model 1104 provides a depth output for each pixel in subject frame 1102, depth ground truth for Iₜ function 1110 may only provide estimated ground truth values for a subset of the pixels in subject frame 1102.

Depth ground truth for It function 1110 may generate estimated depth ground truth values by various different techniques. In one aspect, a sensor fusion function (or module) uses one or more sensors to directly sense depth information from a portion of a subject frame. For example, the depth ground truth values may be point cloud data captured by a LiDAR sensor and aligned to subject frame 1102 using the final calibration matrix determined using the cross-sensor calibration techniques of this disclosure described above. Additional information regarding the various aspects of the training architecture of FIG. 11 may be found in U.S. Patent Publication 2023/0023126 A1, published on Jan. 26, 2023, the entire content of which is hereby incorporated by reference.

The depth supervision loss generated by depth supervision loss function 1112 may be masked (using mask operation 1115) based on an explainability mask provided by explainability mask function 1114. The purpose of the explainability mask is to limit the impact of the depth supervision loss to those pixels in subject frame 1102 that do not have explainable (e.g., estimable) depth.

For example, a pixel in subject frame 1102 may be marked as “non-explainable” if the reprojection error for that pixel in the warped image (estimated subject frame 1122) is higher than the value of the loss for the same pixel with respect to the original unwarped context frame 1116. In this example, “warping” refers to the view synthesis operation performed by view synthesis function 1118. In other words, if no associated pixel can be found with respect to original subject frame 1102 for the given pixel in reconstructed subject frame 1122, then the given pixel was probably globally non-static (or relatively static to the camera) in subject frame 1102 and therefore cannot be reasonably explained.

The depth supervision loss generated by depth supervision loss function 1112 and as modified/masked by the explainability mask produced by explainability mask function 1114 is provided as another component to final loss function 1105. As above, though not depicted in the figure, depth supervision loss function 1112 may be associated with a hyperparameter (e.g., a weight) in final loss function 1105, which changes the influence of the depth supervision loss on final loss function 1105.

In an aspect, the final or total (multi-component) loss generated by final loss function 1105 (which may be generated based a depth gradient loss generated by a depth gradient loss function 1108, a (masked) depth supervision loss generated by depth supervision loss function 1112, and/or a photometric loss generated by photometric loss function 1124) is used to update or refine depth model 1104. For example, using gradient descent and/or backpropagation, one or more parameters of depth model 1104 may be refined or updated based on the total loss generated for a given subject frame 1102.

In aspects, this updating may be performed independently and/or sequentially for a set of subject frames 1102 (e.g., using stochastic gradient descent to sequentially update the parameters of the model 1104 based on each subject frame 1102) and/or in based on batches of subject frames 1102 (e.g., using batch gradient descent).

Using architecture 1100, model 1104 thereby learns to generate improved and more accurate depth estimations. During runtime inferencing, trained model 1104 may be used to generate depth output 1106 for an input subject frame 1102. This depth output 1106 can then be used for a variety of purposes, such as autonomous driving and/or driving assist, as discussed above. In some aspects, at runtime, depth model 1104 may be used without consideration or use of other aspects of training architecture 1100, such as context frame(s) 1116, view synthesis function 1118, pose projection function 1120, reconstructed subject frame 1122, photometric loss function 1124, depth gradient loss function 1108, depth ground truth for It function 1110, depth supervision loss function 1112, explainability mask function 1114, and/or final loss function 1105.

Examples of the various aspects of this disclosure may be used individually or in any combination.

Additional aspects of the disclosure are detailed in numbered clauses below.
Clause 1—An apparatus for cross-sensor calibration, the apparatus comprising: a memory for storing a camera image and a point cloud frame; and one or more processors implemented in circuitry and in communication with the memory, the one or more processors configured to: perform a first edge detection process on the camera image to generate an edge detected camera image; perform a second edge detection process on the point cloud frame to generate an edge detected point cloud frame; project the edge detected point cloud frame onto the edge detected camera image using an initial calibration matrix; determine a value of an objective function representing an overlap of points in the edge detected point cloud frame and corresponding edge values in the edge detected camera image; and determine a final calibration matrix based on the value of the objective function.
Clause 2—The apparatus of Clause 1, wherein the one or more processors are further configured to: perform a motion compensation process on the edge detected point cloud frame before the one or more processors project the edge detected point cloud frame onto the edge detected camera image.
Clause 3—The apparatus of any of Clauses 1-2, wherein the one or more processors are further configured to: perform a filtering process on the edge detected camera image to smooth one or more edges in the edge detected camera image, wherein the filtering process is performed before the one or more processors project the edge detected point cloud frame onto the edge detected camera image.
Clause 4—The apparatus of any of Clauses 1-3, wherein the one or more processors are further configured to: determine the point cloud frame from a plurality of point cloud frames, including selecting the point cloud frame that was captured closest in time to the camera image.
Clause 5—The apparatus of any of Clauses 1-4, wherein the one or more processors are further configured to: convert the camera image to grayscale before the one or more processors perform the first edge detection process.
Clause 6—The apparatus of any of Clauses 1-5, wherein the final calibration matrix is a translation and rotation matrix.
Clause 7—The apparatus of any of Clauses 1-5, wherein the final calibration matrix is a 3×4 transformation matrix.
Clause 8—The apparatus of any of Clauses 1-7, wherein to project the edge detected point cloud frame onto the edge detected camera image using the initial calibration matrix, the one or more processors are further configured to: project the edge detected point cloud frame onto the edge detected camera image using the initial calibration matrix and one or more camera intrinsics values of a camera used to capture the camera image.
Clause 9—The apparatus of any of Clauses 1-8, wherein to determine the value of the objective function representing the overlap of points in the edge detected point cloud frame and corresponding edge pixel values in the edge detected camera image, the one or more processors are configured to: calculate respective products of respective magnitudes of the points in the edge detected point cloud frame and respective corresponding edge values in the edge detected camera image.
Clause 10—The apparatus of Clause 9, wherein the one or more processors are further configured to: apply respective weights to the respective magnitudes of the points in the edge detected point cloud frame based on respective distances of the points in the edge detected point cloud frame relative to a center of the edge detected camera image.
Clause 11—The apparatus of Clause 9, wherein the one or more processors are further configured to: apply respective weights to the respective magnitudes of the points in the edge detected point cloud frame based on respective angles of the points in the edge detected point cloud frame relative to a feature in the camera image.
Clause 12—The apparatus of any of Clauses 1-11, wherein to determine the final calibration matrix based on the value of the objective function, the one or more processors are configured to: update the initial calibration matrix to form an updated calibration matrix; reproject the edge detected point cloud frame onto the edge detected camera image using the updated calibration matrix; determine an updated value of the objective function representing the overlap of points in the edge detected point cloud frame and corresponding edge values in the edge detected camera image; and output the updated calibration matrix as the final calibration matrix based on a comparison of the updated value of the objective function to one or more prior values of the objective function.
Clause 13—The apparatus of any of Clauses 1-12, wherein to determine the final calibration matrix based on the value of the objective function, the one or more processors are configured to: optimize the value of the objective function.
Clause 14—The apparatus of any of Clauses 1-13, wherein the one or more processors are further configured to: apply the final calibration matrix to the point cloud frame to generate a calibrated point cloud frame; and use the calibrated point cloud frame as a ground truth depth for estimating depth in the camera image.
Clause 15—The apparatus of any of Clauses 1-14, further comprising: a camera configured to capture the camera image; and a LiDAR sensor configured to capture the point cloud frame.
Clause 16—The apparatus of Clause 15, wherein the one or more processors are part of an advanced driver assistance system (ADAS).
Clause 17—The apparatus of Clause 16, wherein the apparatus is part of a vehicle.
Clause 18—The apparatus of any of Clauses 1-14, wherein the one or more processors are external to an advanced driver assistance system (ADAS), and wherein the one or more processors are configured to: output the final calibration matrix to the ADAS.
Clause 19-A method of cross-sensor calibration, the method comprising: performing a first edge detection process on a camera image to generate an edge detected camera image; performing a second edge detection process on a point cloud frame to generate an edge detected point cloud frame; projecting the edge detected point cloud frame onto the edge detected camera image using an initial calibration matrix; determining a value of an objective function representing an overlap of points in the edge detected point cloud frame and corresponding edge values in the edge detected camera image; and determining a final calibration matrix based on the value of the objective function.
Clause 20—The method of Clause 19, further comprising: performing a motion compensation process on the edge detected point cloud frame before projecting the project the edge detected point cloud frame onto the edge detected camera image.
Clause 21—The method of any of Clauses 19-20, further comprising: performing a filtering process on the edge detected camera image to smooth one or more edges in the edge detected camera image, wherein the filtering process is performed before projecting the edge detected point cloud frame onto the edge detected camera image.
Clause 22—The method of any of Clauses 19-21, further comprising: determining the point cloud frame from a plurality of point cloud frames, including selecting the point cloud frame that was captured closest in time to the camera image.
Clause 23—The method of any of Clauses 19-22, further comprising: converting the camera image to grayscale before performing the first edge detection process.
Clause 24—The method of any of Clauses 19-23, wherein the final calibration matrix is a translation and rotation matrix.
Clause 25—The method of any of Clauses 19-4, wherein the final calibration matrix is a 3×4 transformation matrix.
Clause 26—The method of any of Clauses 19-25, wherein projecting the edge detected point cloud frame onto the edge detected camera image using the initial calibration matrix comprises: projecting the edge detected point cloud frame onto the edge detected camera image using the initial calibration matrix and one or more camera intrinsics values of a camera used to capture the camera image.
Clause 27—The method of any of Clauses 19-26, wherein determining the value of the objective function representing the overlap of points in the edge detected point cloud frame and corresponding edge pixel values in the edge detected camera image comprises: calculating respective products of respective magnitudes of the points in the edge detected point cloud frame and respective corresponding edge values in the edge detected camera image.
Clause 28—The method of Clause 27, further comprising: applying respective weights to the respective magnitudes of the points in the edge detected point cloud frame based on respective distances of the points in the edge detected point cloud frame relative to a center of the edge detected camera image.
Clause 29—The method of Clause 27, further comprising: applying respective weights to the respective magnitudes of the points in the edge detected point cloud frame based on respective angles of the points in the edge detected point cloud frame relative to a feature in the camera image.
Clause 30—The method of any of Clauses 19-29, wherein determining a final calibration matrix based on the value of the objective function comprises: updating the initial calibration matrix to form an updated calibration matrix; reprojecting the edge detected point cloud frame onto the edge detected camera image using the updated calibration matrix; determining an updated value of the objective function representing the overlap of points in the edge detected point cloud frame and corresponding edge values in the edge detected camera image; and outputting the updated calibration matrix as the final calibration matrix based on a comparison of the updated value of the objective function to one or more prior values of the objective function.
Clause 31—The method of any of Clauses 19-30, wherein determining the final calibration matrix based on the value of the objective function comprises: optimizing the value of the objective function.
Clause 32—The method of any of Clauses 19-31, further comprising: applying the final calibration matrix to the point cloud frame to generate a calibrated point cloud frame; and using the calibrated point cloud frame as a ground truth depth for estimating depth in the camera image.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. An apparatus for cross-sensor calibration, the apparatus comprising:
a memory for storing a camera image and a point cloud frame; and
one or more processors implemented in circuitry and in communication with the memory, the one or more processors configured to:
perform a first edge detection process on the camera image to generate an edge detected camera image;
perform a second edge detection process on the point cloud frame to generate an edge detected point cloud frame;
project the edge detected point cloud frame onto the edge detected camera image using an initial calibration matrix;
determine a value of an objective function representing an overlap of points in the edge detected point cloud frame and corresponding edge values in the edge detected camera image; and
determine a final calibration matrix based on the value of the objective function.

2. The apparatus of claim 1, wherein the one or more processors are further configured to:
perform a motion compensation process on the edge detected point cloud frame before the one or more processors project the edge detected point cloud frame onto the edge detected camera image.

3. The apparatus of claim 1, wherein the one or more processors are further configured to:
perform a filtering process on the edge detected camera image to smooth one or more edges in the edge detected camera image, wherein the filtering process is performed before the one or more processors project the edge detected point cloud frame onto the edge detected camera image.

4. The apparatus of claim 1, wherein the one or more processors are further configured to:
determine the point cloud frame from a plurality of point cloud frames, including selecting the point cloud frame that was captured closest in time to the camera image.

5. The apparatus of claim 1, wherein the one or more processors are further configured to:
convert the camera image to grayscale before the one or more processors perform the first edge detection process.

6. The apparatus of claim 1, wherein the final calibration matrix is a translation and rotation matrix.

7. The apparatus of claim 1, wherein the final calibration matrix is a 3×4 transformation matrix.

8. The apparatus of claim 1, wherein to project the edge detected point cloud frame onto the edge detected camera image using the initial calibration matrix, the one or more processors are further configured to:
project the edge detected point cloud frame onto the edge detected camera image using the initial calibration matrix and one or more camera intrinsics values of a camera used to capture the camera image.

9. The apparatus of claim 1, wherein to determine the value of the objective function representing the overlap of points in the edge detected point cloud frame and corresponding edge pixel values in the edge detected camera image, the one or more processors are configured to:
calculate respective products of respective magnitudes of the points in the edge detected point cloud frame and respective corresponding edge values in the edge detected camera image.

10. The apparatus of claim 9, wherein the one or more processors are further configured to:
apply respective weights to the respective magnitudes of the points in the edge detected point cloud frame based on respective distances of the points in the edge detected point cloud frame relative to a center of the edge detected camera image.

11. The apparatus of claim 9, wherein the one or more processors are further configured to:
apply respective weights to the respective magnitudes of the points in the edge detected point cloud frame based on respective angles of the points in the edge detected point cloud frame relative to a feature in the camera image.

12. The apparatus of claim 1, wherein to determine the final calibration matrix based on the value of the objective function, the one or more processors are configured to:
update the initial calibration matrix to form an updated calibration matrix;
reproject the edge detected point cloud frame onto the edge detected camera image using the updated calibration matrix;
determine an updated value of the objective function representing the overlap of points in the edge detected point cloud frame and corresponding edge values in the edge detected camera image; and
output the updated calibration matrix as the final calibration matrix based on a comparison of the updated value of the objective function to one or more prior values of the objective function.

13. The apparatus of claim 1, wherein to determine the final calibration matrix based on the value of the objective function, the one or more processors are configured to:
optimize the value of the objective function.

14. The apparatus of claim 1, wherein the one or more processors are further configured to:
apply the final calibration matrix to the point cloud frame to generate a calibrated point cloud frame; and
use the calibrated point cloud frame as a ground truth depth for estimating depth in the camera image.

15. The apparatus of claim 1, further comprising:
a camera configured to capture the camera image; and
a LiDAR sensor configured to capture the point cloud frame, and wherein the one or more processors are part of an advanced driver assistance system (ADAS).

16. The apparatus of claim 1, wherein the one or more processors are external to an advanced driver assistance system (ADAS), and wherein the one or more processors are configured to:
output the final calibration matrix to the ADAS.

17. A method of cross-sensor calibration, the method comprising:
performing a first edge detection process on a camera image to generate an edge detected camera image;
performing a second edge detection process on a point cloud frame to generate an edge detected point cloud frame;
projecting the edge detected point cloud frame onto the edge detected camera image using an initial calibration matrix;
determining a value of an objective function representing an overlap of points in the edge detected point cloud frame and corresponding edge values in the edge detected camera image; and
determining a final calibration matrix based on the value of the objective function.

18. The method of claim 17, further comprising:
performing a motion compensation process on the edge detected point cloud frame before projecting the project the edge detected point cloud frame onto the edge detected camera image.

19. The method of claim 17, further comprising:
performing a filtering process on the edge detected camera image to smooth one or more edges in the edge detected camera image, wherein the filtering process is performed before projecting the edge detected point cloud frame onto the edge detected camera image.

20. The method of claim 17, further comprising:
determining the point cloud frame from a plurality of point cloud frames, including selecting the point cloud frame that was captured closest in time to the camera image.

21. The method of claim 17, further comprising:
converting the camera image to grayscale before performing the first edge detection process.

22. The method of claim 17, wherein the final calibration matrix is a translation and rotation matrix.

23. The method of claim 17, wherein the final calibration matrix is a 3×4 transformation matrix.

24. The method of claim 17, wherein projecting the edge detected point cloud frame onto the edge detected camera image using the initial calibration matrix comprises:
projecting the edge detected point cloud frame onto the edge detected camera image using the initial calibration matrix and one or more camera intrinsics values of a camera used to capture the camera image.

25. The method of claim 17, wherein determining the value of the objective function representing the overlap of points in the edge detected point cloud frame and corresponding edge pixel values in the edge detected camera image comprises:
calculating respective products of respective magnitudes of the points in the edge detected point cloud frame and respective corresponding edge values in the edge detected camera image.

26. The method of claim 25, further comprising:
applying respective weights to the respective magnitudes of the points in the edge detected point cloud frame based on respective distances of the points in the edge detected point cloud frame relative to a center of the edge detected camera image.

27. The method of claim 25, further comprising:
applying respective weights to the respective magnitudes of the points in the edge detected point cloud frame based on respective angles of the points in the edge detected point cloud frame relative to a feature in the camera image.

28. The method of claim 17, wherein determining the final calibration matrix based on the value of the objective function:
updating the initial calibration matrix to form an updated calibration matrix;
reprojecting the edge detected point cloud frame onto the edge detected camera image using the updated calibration matrix;
determining an updated value of the objective function representing the overlap of points in the edge detected point cloud frame and corresponding edge values in the edge detected camera image; and
outputting the updated calibration matrix as the final calibration matrix based on a comparison of the updated value of the objective function to one or more prior values of the objective function.

29. The method of any of claim 17, wherein determining the final calibration matrix based on the value of the objective function comprises:
optimizing the value of the objective function.

30. The method of claim 17, further comprising:
applying the final calibration matrix to the point cloud frame to generate a calibrated point cloud frame; and
using the calibrated point cloud frame as a ground truth depth for estimating depth in the camera image.
